(19) United States
(12) Patent Application Publication
(10) Pub. No.: US 2025/0305832 A1
(43) Pub. Date: Oct. 2, 2025

(54) METHOD AND A PREDICTIVE GATE SYSTEM FOR PREDICTING AN EXIT ROUTE OF A USER FROM AN AREA HAVING A RESTRICTED ACCESS

(71) Applicant: KONE Corporation, Helsinki (FI)

(72) Inventors: Mika BELOV, Helsinki (FI); Tapio LAINELA, Helsinki (FI)

(73) Assignee: KONE Corporation, Helsinki (FI)

(21) Appl. No.: 19/233,565

(22) Filed: Jun. 10, 2025

Related U.S. Application Data
(63) Continuation of application No. PCT/FI2023/050037, filed on Jan. 17, 2023.

(51) Int. Cl. G01C 21/20; G01C 21/10; G07C 9/00

(52) U.S. Cl. CPC G01C 21/20; G01C 21/10; G07C 9/00

(57) ABSTRACT

The invention relates to a method for predicting an exit route (420) of a user (140) from an area (110) having a restricted access restricted by a predictive gate system (200) comprising at least two gate devices (130a-130n). The method comprises: obtaining (310) tracking data of the user (140) within the restricted access area (110) from a sensor system (210) comprising a plurality of sensor devices (210a-210n), predicting (320) the exit route (420) of the user (140) within the restricted access area (110) based on the obtained tracking data of the user (140), estimating (330) based on the predicted exit route (420) a gate device (130a) through which the user (140) will exit the restricted access area (110), and controlling (340) the estimated gate device (130a) to allow access for the user (140) to exit the restricted access area (110). The invention relates also to a predictive gate system (200) for predicting an exit route (420) of a user (140) from an area (110) having a restricted access restricted by at least two gate devices (130a-130n).

### TECHNICAL FIELD

The invention concerns in general the technical field of gate systems. Especially the invention concerns predicting exit routes of users from areas having a restricted access restricted by the gate systems.

### BACKGROUND

In some environments, there may be areas with a restricted access, e.g. in elevator environments elevator lobby areas may have restricted access, in station environments platform areas may have restricted access, and/or in airport areas security check areas may have restricted access. The access of users into the restricted access areas may be controlled by using gate devices, which allow access into the restricted access areas only to authorized users. Unauthorized users are not allowed to access through the gate devices into the restricted access areas. Typically, the gate devices may comprise a barrier device, such as door panel(s), turnstile, boom or any other barrier device, to prevent the unauthorized users to access into the restricted access area via the gate devices. The access control into the restricted areas may be based on using keycards; tags; identification codes; such as personal identity number (PIN) code, ID number; and/or biometric technologies, such as fingerprint, facial recognition, iris recognition, retinal scan, voice recognition, etc..

In some cases, the users may be allowed to exit the restricted access areas without the access control, i.e. all users are allowed to access through the gate devices to exit the restricted access areas. For example, the gate device may comprise a sensor system configured to detect when a user is approaching the gate device from the restricted access area side of the gate device, and in response to detecting the approaching user, the barrier device of the gate device is opened to allow the user to exit the restricted access area. The gate devices are nowadays becoming smaller and smaller enabling reduced footprint. Due to the reduced footprint of the gate devices, it may be more challenging to control the opening of barrier devices of the gate devices. For example, in some cases, when a user is leaving the restricted access area, the user may walk through sensing ranges of sensor systems of multiple gate devices causing that barrier devices of one or more gate devices other than the gate device the user is going to use to exit the restricted access area may open by a mistake enabling access also for unauthorized users into the restricted access area through the one or more other gate devices.

Therefore, there is a need to develop further solutions for controlling operation of gate devices, especially gate devices with a reduced footprint.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method and a predictive gate system for predicting an exit route of a user from an area having a restricted access. Another objective of the invention is that the method and the predictive gate system for predicting an exit route of a user from an area having a restricted access improve controlling operation of gate devices.

The objectives of the invention are reached by a method and a predictive system as defined by the respective independent claims.

According to a first aspect, a method for predicting an exit route of a user from an area having a restricted access restricted by a predictive gate system comprising at least two gate devices is provided, wherein the method comprises: obtaining tracking data of the user within the restricted access area from a sensor system comprising a plurality of sensor devices, predicting the exit route of the user within the restricted access area based on the obtained tracking data of the user, estimating based on the predicted exit route a gate device belonging to the at least two gate devices of the predictive gate system through which the user will exit the restricted access area, and controlling the estimated gate device to allow access for the user to exit the restricted access area.

The method may further comprise generating, by at least one beam-based indication device of an indication system, visual guidance information based on the predicted exit route of the user to guide the user to exit the restricted access area through the estimated gate device.

The at least one beam-based indication device may comprise at least one projector-based indication device and/or at least one laser-based indication device.

Alternatively or in addition, the method may further comprise, in response to controlling the estimated gate device to allow the access for the user, controlling other at least one gate device of the at least two gate devices of the predictive gate system to prevent access of the user to exit the restricted access area.

The obtained tracking data of the user may comprise a travel speed of the user and a direction of the travel of the user.

According to a second aspect, a predictive gate system for predicting an exit route of a user from an area having a restricted access restricted by at least two gate devices is provided, wherein the predictive gate system comprises: a gate device arrangement comprising the at least two gate devices, a sensor system comprising a plurality of sensor devices configured to provide tracking data of one or more users within the restricted access area, and a control system configured to: obtain tracking data of the user within the restricted access area from the sensor system, predict the exit route of the user within the restricted access area based on the obtained tracking data of the user, estimate based on the predicted exit route a gate device belonging to the at least two gate devices of the predictive gate system through which the user will exit the restricted access area, control the estimated gate device to allow access for the user to exit the restricted access area.

The predictive gate system may further comprise an indication system comprising at least one beam-based indication device, wherein the control system may further be configured to control the at least one beam-based indication device of the indication system to generate visual guidance information based on the predicted exit route to guide the user to exit the restricted access area through the estimated gate device.

The at least one beam-based indication device may comprise at least one projector-based indication device and/or at least one laser-based indication device.

Alternatively or in addition, the control system may further be configured, in response to controlling the estimated gate device to allow the access for the user, to control other at least one gate device of the at least two gate devices of the predictive gate system to prevent access of the user to exit the restricted access area.

The obtained tracking data of the user may comprise a travel speed of the user and a direction of the travel of the user.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an environment, into which a predictive gate system may be implemented.

FIG. 2 illustrates schematically an example of the entities of the predictive gate system.

FIG. 3 illustrates schematically an example of a method for predicting an exit route of a user from a restricted access area.

FIGS. 4A-4C illustrate an example of a prediction situation.

FIG. 5 illustrates schematically an example of components of a control system.

### DESCRIPTION OF THE EXEMPLIFYING EMBODIMENTS

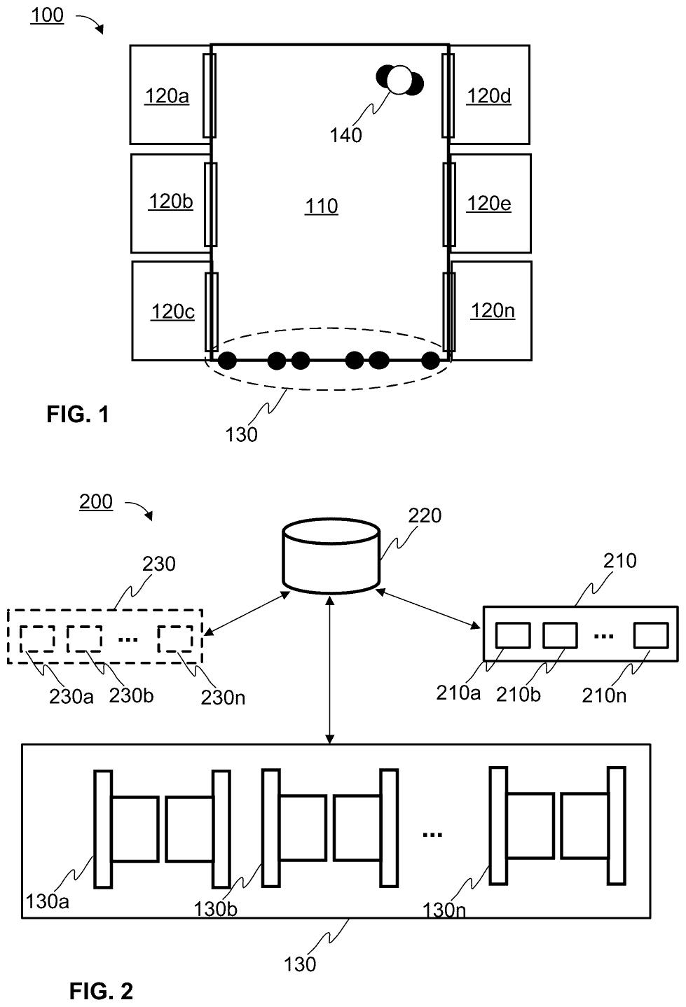

FIG. 1 illustrates schematically an example of an environment 100, into which a predictive gate system 200 may be implemented. FIG. 1 illustrates top view of the example environment 100. The environment 100 comprises an area having a restricted access, i.e. a restricted access area 110. The restricted access area 110 is restricted by the predictive gate system 200. For sake of clarity the predictive gate system 200 is shown in FIG. 1 partly by illustrating only a gate arrangement 130 of the predictive gate system 200. The predictive gate system 200 is discussed more later in this application by referring to FIG. 2. The environment 100 may for example be an elevator environment as illustrated in FIG. 1 or any other environment comprising a restricted access area 110. In addition to the restricted access area 110, the environment 100 being the elevator environment may comprise an elevator system comprising one or more elevators 120a-120n. Each elevator 120a-120n comprises an elevator car configured to travel along a respective elevator shaft. The elevator system may also form an elevator group, i.e. group of two or more elevator cars each travelling along a separate elevator shaft configured to operate as a unit serving the same landings. The elevator system further comprises one or more other known elevator related entities, e.g. an elevator control system, hoisting system, user interface devices, safety circuit and devices, elevator brakes, elevator doors, etc., which are not shown in FIG. 1 for sake of clarity.

FIG. 2 illustrates schematically an example of the entities of the predictive gate system 200. The predictive gate system 200 comprises the gate device arrangement 130, a sensor system 210, and a control system 220. The control system 220 is communicatively coupled to the gate device arrangement 130. The communication between the control system 220 and the gate device arrangement 130 may be based on one or more known communication technologies, either wired or wireless. Furthermore, the control system 220 is communicatively coupled to the sensor system 210. The communication between the control system 220 and the sensor system 210 may be based on one or more known communication technologies, either wired or wireless. The implementation of the control system 220 may be done as a stand-alone unit or as a distributed control environment between a plurality of stand-alone units providing distributed controlling resource. Preferably, the control system 220 may be implemented as the distributed control environment. The control system 220 may for example comprise at least part of the elevator control system, a common controller of the gate device arrangement 130, a controller of a single gate device 130a-130n of the gate device arrangement 130, an external controller unit, a remote controller unit, and/or some other controller unit. The gate device arrangement 130 comprises at least two gate devices 130a-130n. In the example of FIG. 1 the gate device arrangement 130 of the predictive gate system 200 comprises three gate devices 130a-130n, but it is only a non-limiting example, and the gate device arrangement 130 of the predictive gate system 200 may comprise any other number of gate devices 130a-130n, wherein the number of gate devices 130a-130n is at least two. The at least two gate devices 130a-130n may each preferably have a reduced footprint. The reduced footprint means that the surface area required by the gate device 130a-130n is reduced, which enables that the space required by the gate device 130a-130n may be reduced. The sensor system 210 comprises a plurality of sensor devices 210a-210n configured to provide tracking data of one or more users 140 within the restricted access area 110. The plurality of sensor devices 210a-210n of the sensor system 210 may comprise at least one gate device integrated sensor device, at least one elevator system integrated sensor device, and/or at least one separate sensor device. The at least one gate device integrated sensor device may be arranged to at least one gate device 130a-130n of the gate device arrangement 130, e.g. to a frame structure of the at least one gate device 130a-130n of the gate device arrangement 130. The at least one elevator system integrated sensor device may for example be arranged to at least one entity of the elevator system, e.g. to at least one user interface device of the elevator system. The at least one user interface device of the elevator system may comprise at least one elevator call device (e.g. a landing call device, such as a landing call station (LCS), and/or a destination call device, such as a destination operation panels (DOP)), and/or at least one elevator indicator device (e.g. elevator identifier device (EID) and/or a destination guide device (DG)) providing elevator related guiding information, such as elevator identifier information, elevator location information, and/or elevator car next stop information. The at least one separate sensor device may be arranged within the environment 100, e.g. to a ceiling, to a wall, to a floor, and/or to a pedestal within the environment 100. The plurality of sensor devices 210a-210n may for example be people mobility detecting sensors based on e.g. people counting, area heatmap, Time of Flight (TOF), motion detection, and/or utilizing some mobile sensing technology for capturing people location and movement direction. The predictive gate system 200 may further comprise an indication system 230. The control system 220 is communicatively coupled to the indication system 230. The communication between the control system 220 and the indication system 230 may be based on one or more known communication technologies, either wired or wireless. The indication system 230 may comprise at least one beam-based indication device 230a-230n configured to generate visual guidance information. The at least one beam-based indication device 230a-230n may generate the visual guidance information by projecting the visual guidance information on the floor of the restricted access area 110. The at least one beam-based indication device 230a-230n may comprise at least one projector-based indication device and/or at least one laser-based indication device. The at least one beam-based indication device 230a-230n may be arranged so that it is capable to generate the visual guidance information on the floor of the restricted access area 110. For example, the at least one beam-based indication device 230a-230n may be arranged to a ceiling, to a wall, and/or to a pedestal so that it is capable to generate the visual guidance information on the floor of the restricted access area 110.

The access of users into the restricted access area 110 may be controlled by using the gate device arrangement 130 of the predictive gate system 200, which allow access into the restricted access area 110 only to authorized users. Unauthorized users are not allowed to access through the gate device arrangement 130 into the restricted access area 110. Each gate device 130a-130n of the gate device arrangement 130 may comprise a barrier device, e.g. a door panel(s), a turnstile, a boom or any other barrier device, to prevent the unauthorized users to access into the restricted access area 110 via said gate device 130a-130n The access control into the restricted access area 110 may for example be based on using keycards; tags; identification codes; such as personal identity number (PIN) code, ID number; and/or biometric technologies, such as fingerprint, facial recognition, iris recognition, retinal scan, voice recognition, etc..

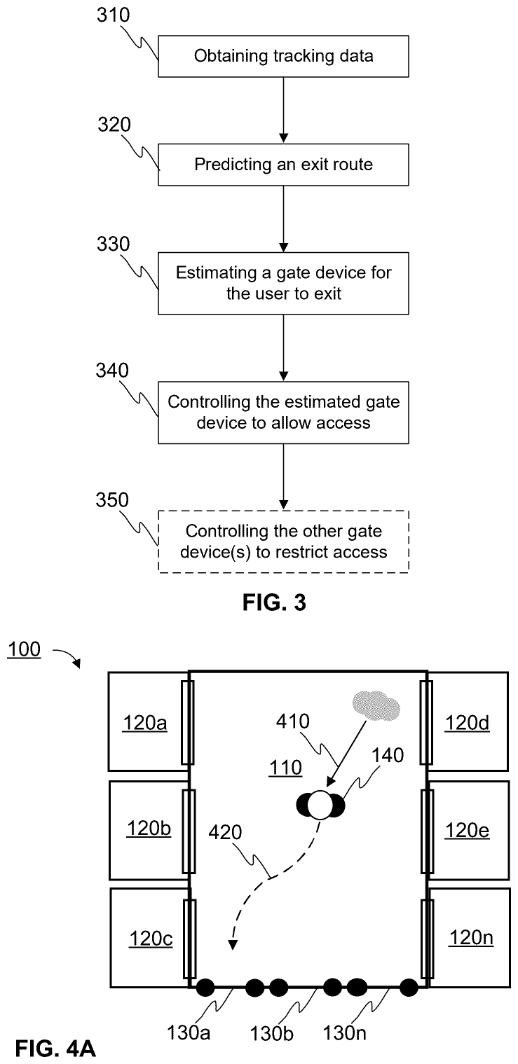

Next an example of a method for predicting an exit route 420 of a user 140 from the restricted access area 110 is described by referring to FIG. 3. FIG. 3 schematically illustrates the invention as a flow chart. The method is described for predicting the exit route 420 of one user 140, but the exit routes of more than one user 140 may be predicted similarly.

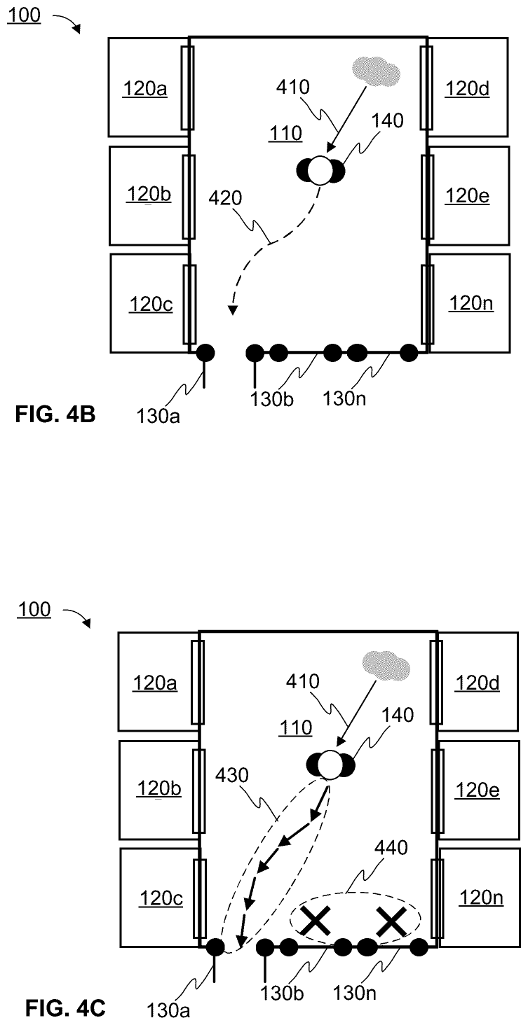

At a step 310, the control system 220 of the predictive gate system 200 obtains tracking data of the user 140 within the restricted access area 110 from the sensor system 210 of the predictive gate system 200. The obtained tracking data of the user 140 may for example comprise a travel speed of the user 140 and a direction of the travel of the user 140. In FIGS. 4A-4C an example prediction situation is illustrated at different steps of the method. In FIG. 4A the user 140 has travelled, e.g. walked, from a first location to a second location within the restricted access area 110 along a travel route 410 and the control system 220 obtains the tracking data of the user 140, when the user 140 travels from the first location to the second location within the restricted access area 110 along the travel route 410.

At a step 320, the control system 220 of the predictive gate system 200 predicts the exit route 420 of the user 140 within the restricted access area 110 based on the obtained tracking data of the user 140. The example of FIG. 4A illustrates further the predicted exit route 420 of the user 140 that is predicted based on the obtained tracking data of the user 140. The prediction of the exit route 420 of the user 140 may be based directly on the obtained tracking data of the user 140, e.g. on the travel direction of the user 140 and the travel speed of the user 140. Alternatively or in addition, the prediction of the exit route 420 of the user 140 may be based indirectly on the obtained tracking data of the user 140, i.e. based on data derived from the obtained tracking data of the user 140, e.g. data indicating from which elevator 120a-120n the user 140 is originating, data indicating from which area of the restricted access area 110 the user 140 is originating (for example the user 140 may be originating also from some door located within the restricted access area 140), data indicating whether the user 140 has something extra with them (e.g. a suitcase, or a bicycle, etc. from where assumptions may be made), and/or user indicated direction information (e.g. the user 140 may be using some guidance application or the user 140 may be looking some guidance indicators). According to an example, the control system 220 may further use predefined direction information of the user 140 (e.g. based on previously learned behavior of a frequent building user) in the prediction of the exit route 420 of the user 140.

At a step 330, the control system 220 of the predictive gate system 200 estimates based on the predicted exit route 420 a gate device 130a belonging to the gate device arrangement 130 of the predictive gate system 200 through which the user 140 will exit the restricted access area 110. For example, the control system 220 may estimate based on the predicted exit route 420 of the user 140 the gate device 130a through which the user will most likely exit the restricted area 110. In the example of FIG. 4A, the estimated gate device is the gate device 130a of the gate device arrangement 130.

At a step 340, the control system 220 of the predictive gate system 200 controls the estimated gate device 130a to allow access for the user 140 to exit the restricted access area 110 through the estimated gate device 130a. In other words, the control system 220 controls the barrier device of the estimated gate device 130a to open in order to allow the access for the user 140 to exit the restricted access area 110 through the estimated gate device 130a. This is illustrated in the example of FIG. 4B, wherein the estimated gate device 130a is opened in order to allow the user 140 to exit the restricted access area 110 through the estimated gate device 130a.

In response to controlling the estimated gate device 130a to allow the access for the user 140 at the step 340, the control system 220 of the predictive gate system 200 may further control at a step 350 other gate device(s) 130b-130n of the gate device arrangement 130 of the predictive gate system 200 than the estimated gate device 130a to prevent access of the user 140 to exit the restricted access area 110. In other words, the control system 220 controls the barrier device of the other gate device(s) 130b-130n to remain closed to prevent access of the user 140 to exit the restricted access area 110 through the other gate devices 130b-130n.

According to an example, the control system 220 of the predictive gate system 200 may further control the at least one beam-based indication device 230a-230n of the indication system 230 of the predictive gate system 200 to generate visual guidance information 430, 440 based on the predicted exit route 420 to guide the user 140 to exit the restricted access area 110 through the estimated gate device 130a. The visual guidance information 430, 440 may for example comprise first visual guidance information 430 indicating the predicted exit route 420 through the estimated gate device 130a and/or a second visual guiding information 440 indicating the restricted access by the other gate devices 130b-130n. This is illustrated in an example of FIG. 4C, wherein the first visual guidance information 430 and the second visual guidance information 440 are projected on the floor of the restricted access area 110 by the at least one beam-based indication device 230a-230n of the indication system 230.

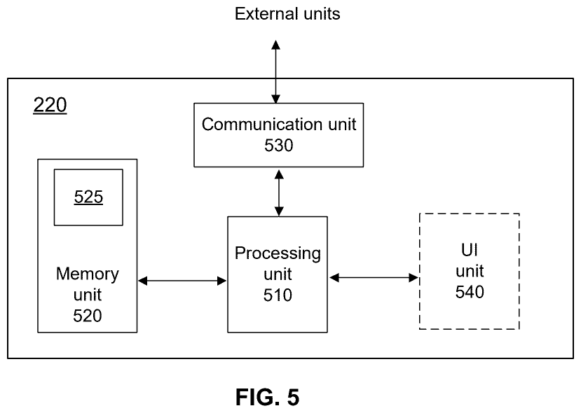

FIG. 5 illustrates schematically an example of components of the control system 220. The control system 220 may comprise a processing unit 510 comprising one or more processors, a memory unit 520 comprising one or more memories, a communication unit 530 comprising one or more communication devices, and possibly a user interface (UI) unit 540. The mentioned elements may be communicatively coupled to each other with e.g. an internal bus. The memory unit 520 may store and maintain portions of a computer program (code) 525, the obtained image data, and any other data. The computer program 525 may comprise instructions which, when the computer program 525 is executed by the processing unit 510 of the control system 220 may cause the processing unit 510, and thus the control system 220 to carry out desired tasks, e.g. one or more of the method steps described above. The processing unit 510 may thus be arranged to access the memory unit 520 and retrieve and store any information therefrom and thereto. For sake of clarity, the processor herein refers to any unit suitable for processing information and control the operation of the control system 220, among other tasks. The operations may also be implemented with a microcontroller solution with embedded software. Similarly, the memory unit 520 is not limited to a certain type of memory only, but any memory type suitable for storing the described pieces of information may be applied in the context of the present invention. The communication unit 530 provides one or more communication interfaces for communication with any other unit, e.g. the plurality of sensor devices 210a-210n of the sensor system 210, the at least two gate devices 130a-130n of the gate device arrangement 130, the at least one beam-based indication device 230a-230n of the indication system 230, and/or with any other unit. The user interface unit 540 may comprise one or more input/output (I/O) devices, such as buttons, keyboard, touch screen, microphone, loudspeaker, display and so on, for receiving user input and outputting information. The computer program 525 may be a computer program product that may be comprised in a tangible nonvolatile (non-transitory) computer-readable medium bearing the computer program code 525 embodied therein for use with a computer, i.e. the control system 220.

The predictive gate system 200 and the method discussed above improve controlling operation of gate devices, which in turn enables an improved user experience.

The specific examples provided in the description given above should not be construed as limiting the applicability and/or the interpretation of the appended claims. Lists and groups of examples provided in the description given above are not exhaustive unless otherwise explicitly stated.

1. A method for predicting an exit route of a user from an area having a restricted access restricted by a predictive gate system comprising at least two gate devices, the method comprises:
obtaining tracking data of the user within the restricted access area from a sensor system comprising a plurality of sensor devices,
predicting the exit route of the user within the restricted access area based on the obtained tracking data of the user,
estimating based on the predicted exit route a gate device belonging to the at least two gate devices of the predictive gate system through which the user will exit the restricted access area, and
controlling the estimated gate device to allow access for the user to exit the restricted access area.

2. The method according to claim 1, further comprising generating, by at least one beam-based indication device of an indication system, visual guidance information based on the predicted exit route of the user to guide the user to exit the restricted access area through the estimated gate device.

3. The method according to claim 2, wherein the at least one beam-based indication device comprises at least one projector-based indication device and/or at least one laser-based indication device.

4. The method according to claim 1 further comprising, in response to controlling the estimated gate device to allow the access for the user, controlling other at least one gate device of the at least two gate devices of the predictive gate system to prevent access of the user to exit the restricted access area.

5. The method according to claim 1, wherein the obtained tracking data of the user comprises a travel speed of the user and a direction of the travel of the user.

6. A predictive gate system for predicting an exit route of a user from an area having a restricted access restricted by at least two gate devices, the predictive gate system comprising:
a gate device arrangement comprising the at least two gate devices,
a sensor system comprising a plurality of sensor devices configured to provide tracking data of one or more users within the restricted access area, and
a control system configured to:
obtain tracking data of the user within the restricted access area from the sensor system,
predict the exit route of the user within the restricted access area based on the obtained tracking data of the user,
estimate based on the predicted exit route a gate device belonging to the at least two gate devices of the predictive gate system through which the user will exit the restricted access area,
control the estimated gate device to allow access for the user to exit the restricted access area.

7. The predictive gate system according to claim 6, further comprising an indication system comprising at least one beam-based indication device, wherein the control system is further configured to control the at least one beam-based indication device of the indication system to generate visual guidance information based on the predicted exit route to guide the user to exit the restricted access area through the estimated gate device.

8. The predictive gate system according to claim 7, wherein the at least one beam-based indication device comprises at least one projector-based indication device and/or at least one laser-based indication device.

9. The predictive gate system according to claim 6, wherein the control system is further configured, in response to controlling the estimated gate device to allow the access for the user, to control other at least one gate device of the at least two gate devices of the predictive gate system to prevent access of the user to exit the restricted access area.

10. The predictive gate system according to claim 6, wherein the obtained tracking data of the user comprises a travel speed of the user and a direction of the travel of the user.

11. The method according to claim 2 further comprising, in response to controlling the estimated gate device to allow the access for the user, controlling other at least one gate device of the at least two gate devices of the predictive gate system to prevent access of the user to exit the restricted access area.

12. The method according to claim 3 further comprising, in response to controlling the estimated gate device to allow the access for the user, controlling other at least one gate device of the at least two gate devices of the predictive gate system to prevent access of the user to exit the restricted access area.

13. The method according to claim 2, wherein the obtained tracking data of the user comprises a travel speed of the user and a direction of the travel of the user.

14. The method according to claim 3, wherein the obtained tracking data of the user comprises a travel speed of the user and a direction of the travel of the user.

15. The predictive gate system according to claim 7, wherein the control system is further configured, in response to controlling the estimated gate device to allow the access for the user, to control other at least one gate device of the at least two gate devices of the predictive gate system to prevent access of the user to exit the restricted access area.

16. The predictive gate system according to claim 8, wherein the control system is further configured, in response to controlling the estimated gate device to allow the access for the user, to control other at least one gate device of the at least two gate devices of the predictive gate system to prevent access of the user to exit the restricted access area.

17. The predictive gate system according to claim 7, wherein the obtained tracking data of the user comprises a travel speed of the user and a direction of the travel of the user.

18. The predictive gate system according to claim 8, wherein the obtained tracking data of the user comprises a travel speed of the user and a direction of the travel of the user.

19. The predictive gate system according to claim 9, wherein the obtained tracking data of the user comprises a travel speed of the user and a direction of the travel of the user.
